(19) United States
(12) Patent Application Publication
(10) Pub. No.: US 2005/0284023 A1
(43) Pub. Date: Dec. 29, 2005

(54) Window shutter system with operable louvers

(75) Inventor: Trey Brant O'Hair, Lubbock, TX (US)

Correspondence Address: CRUTSINGER & BOOTH, 1601 ELM STREET, SUITE 1950, DALLAS, TX, 752014744, US

(73) Assignee: O'Hair Investments, Inc., Lubbock, TX (US)

(21) Appl. No.: 10/874,844

(22) Filed: Jun. 23, 2004

(51) Int. Cl. E06B 7/08

(52) U.S. Cl. 49/74.1

(57) ABSTRACT

A shutter panel apparatus having a shutter frame with a pair of stiles, spaced apart and generally parallel to one another, and a bottom rail and a top rail, each connected to the stiles. A plurality of generally parallel louvers are rotatably connected to the shutter frame such that each louver is rotatable along a longitudinal axis. The top rail is non-linear in shape and has a back face and a front face, the back face of the top rail having a recess therein for receiving the first end of an upper louver, the first end of the upper louver rotatably connected to the top rail. The invention has several embodiments and allows for the rotation of an upper louver or louvers where the top rail is arched, semi-circular or elliptical. The invention further allows for rotation of an upper louver or louvers where the shutter frame is circular, hexagonal or the like, and where the top rail is angled with respect to the stiles. Ideally, the invention allows the upper louvers to rotate through the same degree of rotation as the other louvers. The end of the upper louver has a notch which cooperates with the recess in the frame to allow rotation of the upper louver which could not be realized without the recess and notch. The notch can take more than one particular shape to cooperate with the recess.

### CROSS-REFERENCE TO RELATED APPLICATION

Not applicable

### STATEMENT REGARDING FEDERALLY SPONSORED RESEARCH OR DEVELOPMENT

No applicable

### REFERENCE TO MICROFICHE APPENDIX

Not applicable

### TECHNICAL FIELD

This invention relates to window shutters with movable, or rotatable, louvers. More specifically, this invention relates to a method and apparatus for window shutters with horizontal louvers with substantially full-range of rotational movement including in an arched top, angled top or non-rectangular area.

### BACKGROUND

The shutter industry has long provided a rectangular panel with a plurality of horizontal louvers, which rotate or pivot about a horizontal axes. Typical shutter panels provide a plurality of parallel louvers, each of which rotate to the same degree and which are often connected by a tilt or control rod for ease of operation. The louvers move in unison when the tilt rod is moved.

However, problems exist where the shutter panel is not rectangular in shape. Such a non-rectangular panel includes generally rectangular panels having an arched or angled top rail or shutter panels, which are elliptical, circular, semi-circular, eyebrow shaped, hexagonal, or octagonal. Such a panel may have an arched top rail, with a single radius, multiple radii (elliptical) or otherwise non-rectangular arch, or it may be angled with respect to the louver axes. Where the shutter panel is one of these shapes, the parallel louvers at the top of the panel, or wherever the panel is not rectangular, are fixed (or do not rotate), or rotate to a lesser degree than the remaining louvers. Conventional shutter panels with such top rails do not allow all of the louvers to rotate fully. The upper louver or louvers are fixed (not pivoting at all), or are provided with a limited movement. Since the upper louvers do not pivot, the shutter does not provide as much light control as desirable, when the louvers are open, as would a shutter wherein all of the louvers rotated. Where the upper louver is movable to a lesser degree than the typical louvers, it must be operated separately from the majority of the louvers, or, if connected through the tilt rod, then the rotation of the majority louvers is limited. Further, the fixed upper louver presents an aesthetically displeasing panel when the movable louvers are open.

The object of the invention is to provide a shutter panel design for non-rectangular shaped panels wherein the upper louvers are fully operable or operable to the same degree as the typical louvers.

### SUMMARY OF THE INVENTION

A shutter panel is presented which allows for the rotation of its parallel louvers, even in a non-rectangular panel. For example, in a panel with an arched top rail, the upper louver or louvers, unlike in prior art panels, are capable of rotation along their longitudinal axes. Preferably, the upper louvers rotate through a range of motion identical to that of the other louvers. To achieve this rotational ability, the top arched rail, in this example is provided with a recess for receiving the end of the upper louver. The end of the upper louver is provided with a corresponding notch which cooperates with the recess to allow movement, or greater movement, of the louver than would otherwise be allowed.

The end of the louver can be rotatably connected to a panel stile or directly to the arched top rail. In the latter case, a pivot face is provided in the recess, preferably perpendicular to the louver axis.

The notch in the louver end can take various shapes, but generally has an axial portion co-extensive with the length of the recess and a contoured portion which cooperates with the arched rail. The contoured portion can be linear or non-linear.

The inventive concept can be modified to provide rotational louvers for various shaped panels. In one embodiment, multiple recesses are provided, each corresponding to a separate louver where multiple louvers are located within the non-rectangular top rail area. In another embodiment, a recess is provided for each end of a louver, such as where a louver is with the area of a top rail which is semi-circular or a partial ellipse. A louver in such a case can be notched at both ends. The inventive concept herein is also applicable to other non-rectangular shutter panels, such as where a rail or stile is arched, elliptical or angled with respect to the louver axis. Circular, hexagonal, and other shaped panels can employ the concept of the invention.

The inventive concept presents advantages over prior art shutter panels. The invention allows for rotation of shutter louvers within a non-rectangular portion of a shutter panel. The invention preferably allows full-rotation of louvers in the affected portion of the panel such that these louvers rotate to the same degree as the louvers in the rectangular area of the panel. A further advantage of the invention is the capability to simultaneously operate all of the louvers on the panel. A further advantage is realized in providing a mere aesthetically pleasing shutter panel where the upper louvers rotate. The rotation of what would otherwise be fixed louvers, or the fuller rotation of what would be louvers with relatively limited rotation, allows for greater light control.

### BRIEF DESCRIPTION OF THE DRAWINGS

The invention will be more fully understood through the following further description thereof with reference to the accompanying drawings wherein:

FIG. 1 is a front orthogonal view of a typical prior art shutter;

FIG. 1A is an exploded view of FIG. 1;

FIG. 2 is a front elevational view of prior art shutter panels having arched top rails and movable horizontal louvers;

FIG. 3 is a front elevational view of prior art shutter panels having arched top rails and fixed upper louvers;

FIG. 4 is a front elevational view of a prior art shutter panel having an angled top rail and fixed upper louvers;

FIG. 5 is a front orthogonal view of a shutter panel of the invention having an arched top rail and movable louvers;

FIG. 6 is a rear orthogonal view of the shutter panel of FIG. 5;

FIG. 7 is a partial and exploded rear view of the shutter panel of FIG. 10, taken along line 7-7.

FIG. 8 is a cross-sectional elevational view of the top rail of the shutter panel of FIG. 10 taken along line 8-8 with the louvers in a closed position;

FIG. 9 is the cross-sectional view of FIG. 8 with the louvers in an open position;

FIG. 10 is a rear orthogonal view of a shutter panel having an arched top rail with recesses for receiving both ends of the upper louvers;

FIG. 11 is a front orthogonal view of the shutter panel of FIG. 10;

FIG. 12 is a rear orthogonal view of a shutter panel having an angled top rail;

FIG. 13 is a front orthogonal view of the shutter panel of FIG. 12;

FIG. 14 is a front orthogonal view of a circular shutter panel;

FIG. 15 is a front elevational view of an hexagonal shutter; and

FIG. 16 is a front elevational view of an octagonal shutter.

### DETAILED DESCRIPTION OF ILLUSTRATIVE EMBODIMENTS

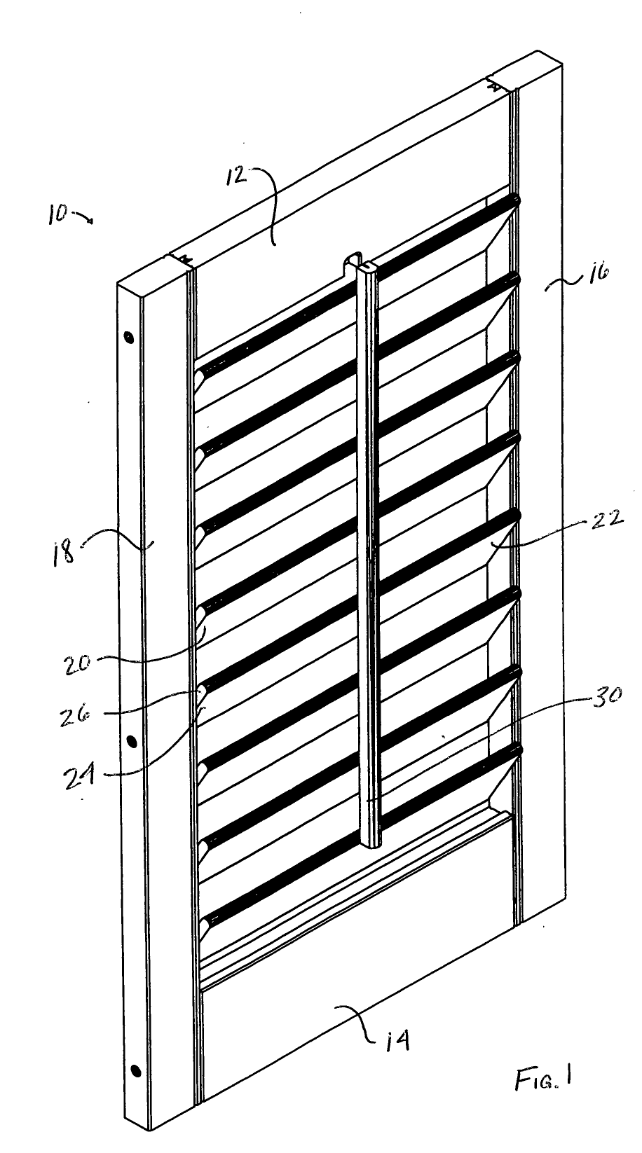

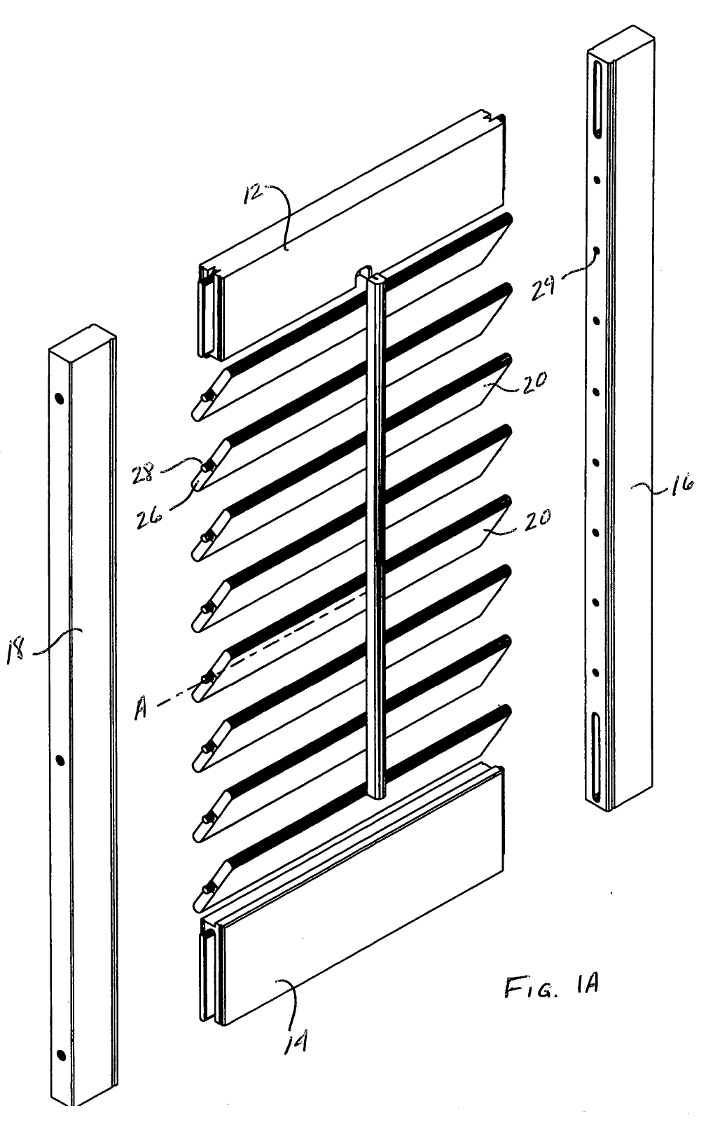

FIGS. 1 and 1A show the general configuration of a typical rectangular panel shutter assembly 10 to present shutter terminology. The panel 10 includes a frame that comprises a pair of rails, top rail 12 and bottom rail 14, and a pair of vertical stiles, right stile 16 and left stile 18. In a rectangular shutter panel, the top and bottom rails are both horizontal. The rails are connected, at their ends, to the stiles by any conventional stile-to-rail joining. Shown are stiles connected to the rails by mortise and tenon. The frame defines an opening in which a plurality of horizontal louvers 20 are located. Each louver 20 is movable, pivoting or rotating along a horizontal louver axis A. Panels may be connected to a window along one of the stiles 16 or 18, either fixedly or on hinges, or may be connected to similar panels, either fixedly or on hinges (not shown). Multiple panels may be used in a single window opening, as desired.

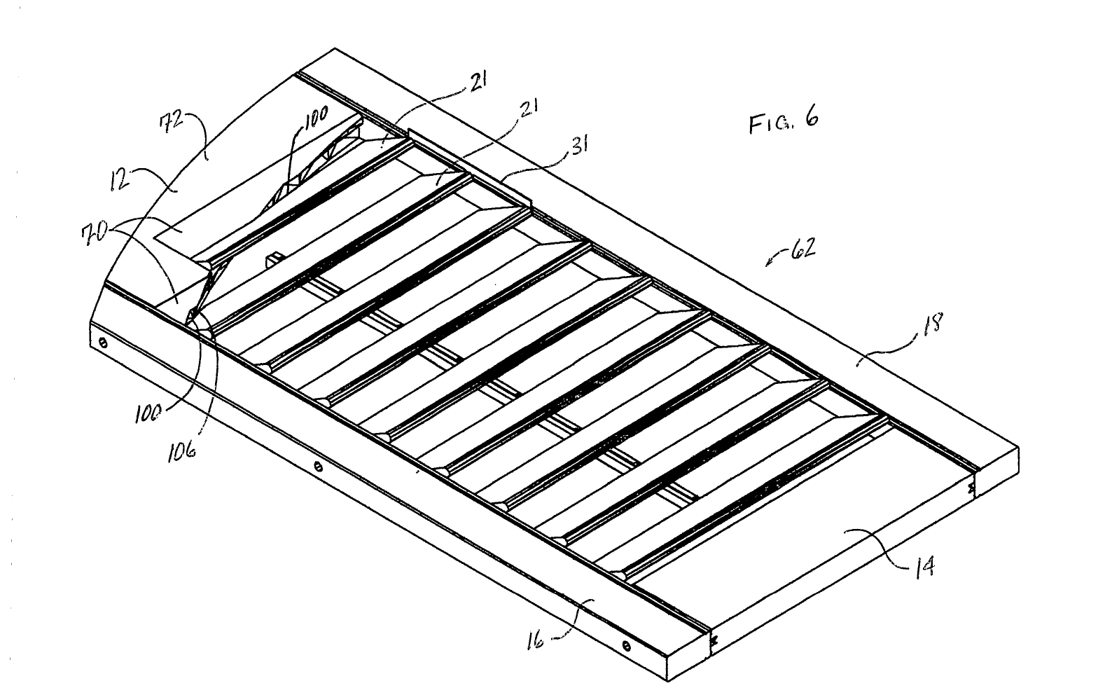

The shutter panel is provided with a plurality of louvers 20. The louvers 20 are connected to one another by tilt rod 30. Each tilt rod 30 connects a plurality of louvers 20 such that they pivot about their respective axes in unison. The tilt rod 30 may be centered in the shutter panel or place off-center, as desired. Each tilt rod 30 is connected to the louvers 20 by a connection system. Various connection systems are known in the art and will not be described in detail. One type of connection system, such as shown in FIG. 6, connects to the rear of the louvers 20 and is not visible from the front of the shutter panel when the louvers are fully closed.

Each louver 20 has right and left ends, 22 and 24, respectively, each having a louver end face 26. Each face 26 is provided with a louver tenon 28, or pin which mates with a corresponding pivot hole 29 in the inner face of the stile. Typically, a louver pin 28 is formed of a plastic material and is inserted into a hole in the face 26 of the louver end. Alternately, a tenon may be integrally formed, projecting from the louver end face. Various designs are known in the art. A tension louver design may be used which stabilizes the louvers such that a certain force is required to rotate the louvers about their axes. Several methods of stabilizing or tensioning the louvers are known in the art and will not be described in detail.

The invention relates to the rotation of parallel louvers in a non-rectangular portion of a shutter panel. One type of non-rectangular shaped panel is a generally rectangular panel with a top rail, which is not parallel to the louver axes. The louvers shown herein are horizontal, but the invention is not limited to conventional designs. On a generally rectangular panel, the top rail may be arched, with a single radius, multiple radii (elliptical) or otherwise non-rectangular arch, or it may be angled with respect to the louver axes. Further non-rectangular panels include circular, elliptical, eye-brow panels or hexagonal, octagonal and other polygonal panels with more than four sides. These shapes are exemplary only, and the invention may be applied to any non-rectangular shaped panel with parallel louvers.

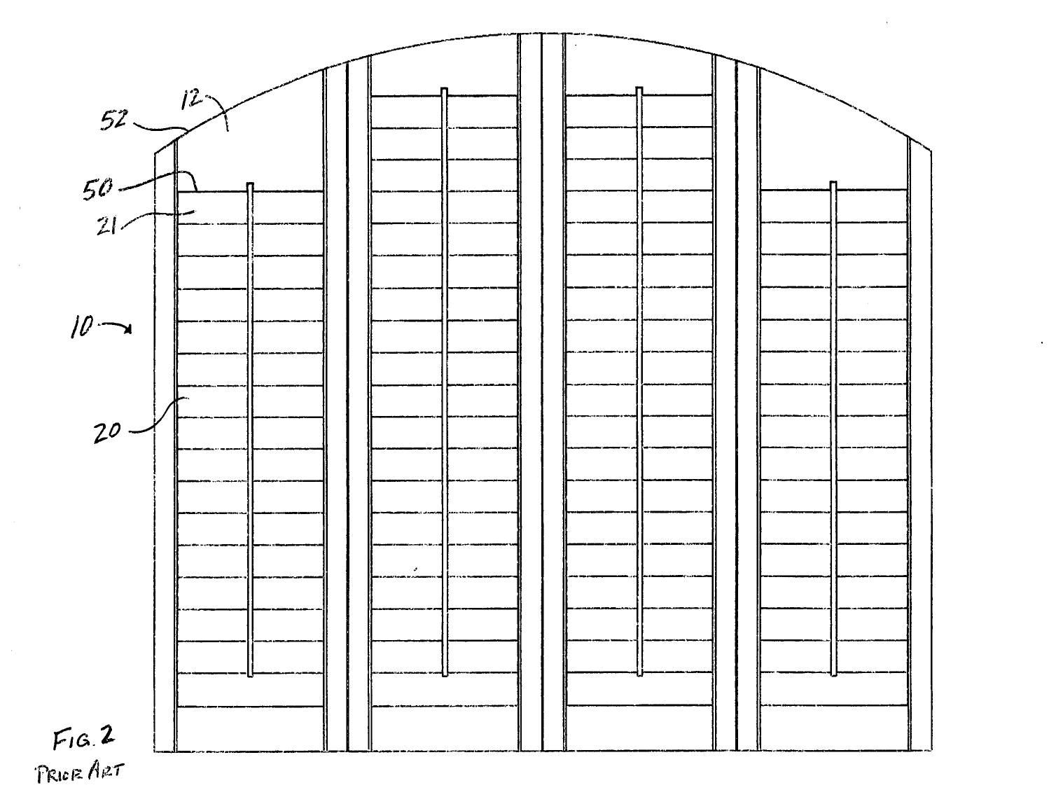

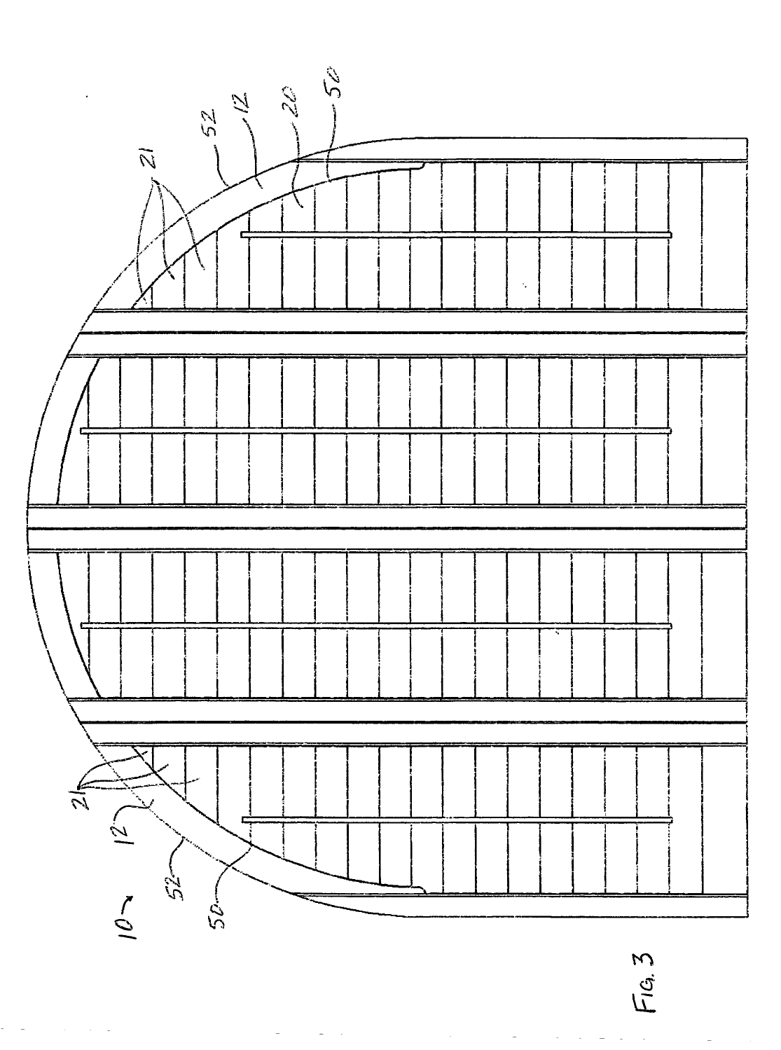

FIGS. 2-4 show general configurations of prior art shutters with non-rectangular top rails. FIGS. 2 and 3 show generally rectangular shutters with an arched top rails. In FIG. 2, each of the louvers 20, including the top-most louvers, fully pivots along its axis. To accomplish full movement, note that the lower edge 50 of the top rail 12 is horizontal, matching the profile of the upper louver 21, and does not match the arched shape of the upper edge 52 of the top rail 12. Although this shutter design allows for full movement of all of the louvers, the top rail 12 is enlarged since the lower and upper edges are not concentric. The resulting top rail 12 is not aesthetically pleasing and covers a large area, limiting the entry of light even when the shutter is open. FIG. 3 solves the aesthetic problem by providing a lower edge 50 and upper edge 52 for the top rail 12 which are concentric. However, conventional shutter panels with non-rectangular top rails, such as those in FIG. 3, do not allow all of the louvers to rotate fully. The upper louvers 21 in FIG. 3 are fixed (not pivoting at all), or are provided with a limited movement. The upper louvers 21 do not pivot to the same degree as the remaining louvers 20.

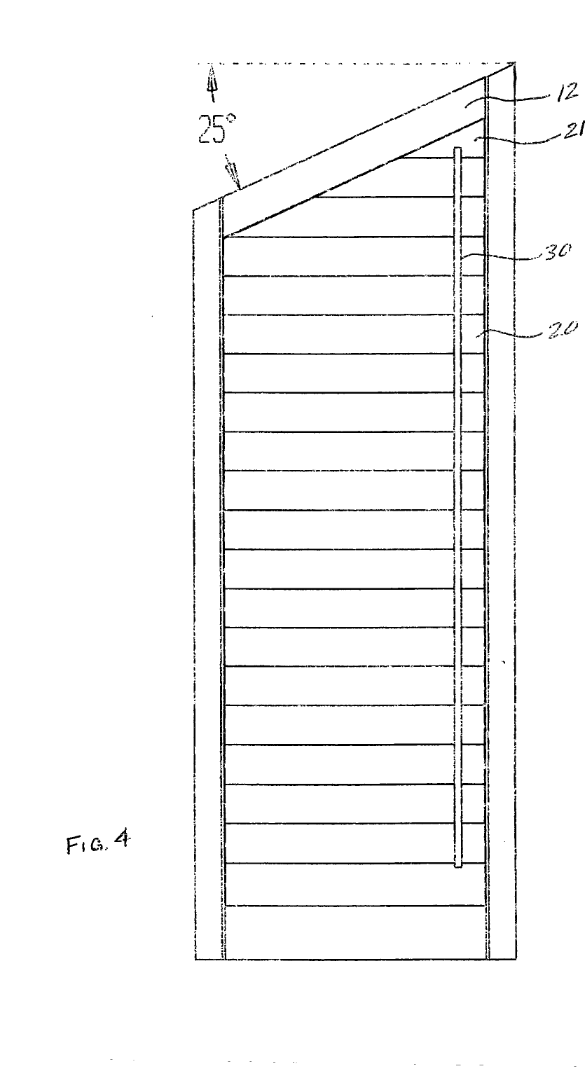

Similarly, FIG. 4 presents a shutter panel having an angled top rail 12 with fixed or limited motion upper louvers 21, depending on the angle of the top rail. The top rail 12 in FIG. 4 is shown at a twenty-five degree angle with respect to the horizontal. Prior art shutters supply movable upper louvers 21 only when the top rail 12 is angled at a twenty-five degree angle or greater. Even then, the louvers are limited in their range of movement, that is, the louvers do not rotate to the same degree as a shutter with a horizontal top rail. Where the top rail 12 is angled less than a twenty-five degree angle, the upper louver or louvers of the prior art are fixed and do not rotate at all.

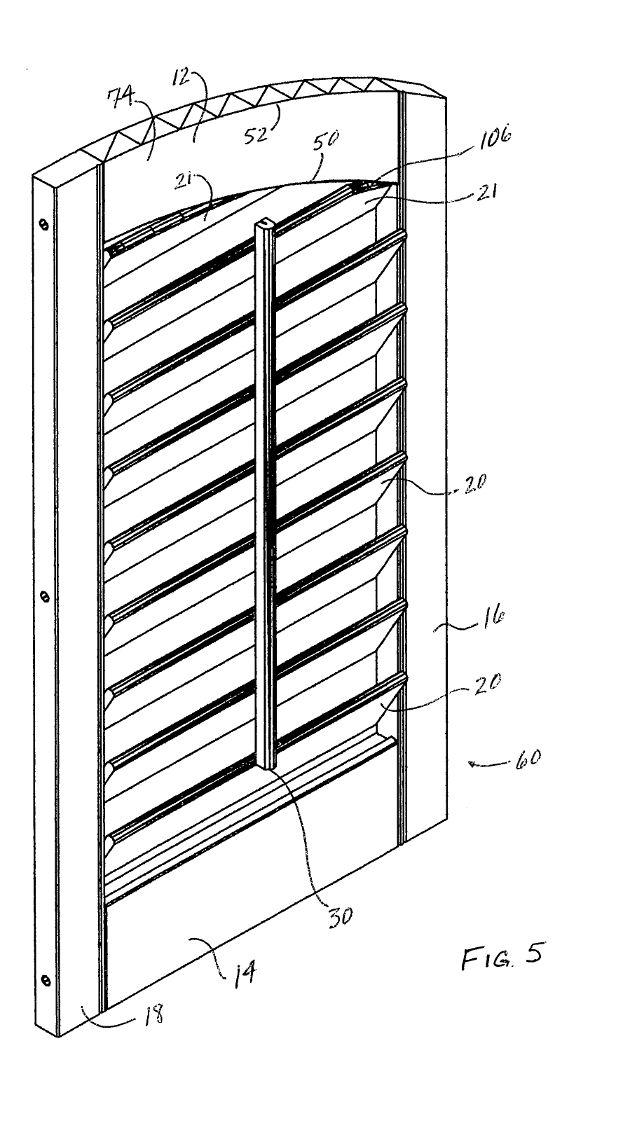

FIGS. 5-6 show one embodiment of the invention as applied to a shutter panel 10 having an arched top rail 12. FIG. 5 shows the front side 60 of the shutter panel 10 and FIG. 6 shows the back side 62 of the panel. Bottom rail 14 is perpendicular to stiles 16 and 18 and parallels the rotational or pivoting axes A of louvers 20, including upper louvers 21. Top rail 12, however, is a curved or arched rail and does not parallel the louver axes. The lower and upper edges, 50 and 52, of the top rail 12 are concentric or substantially concentric. Since the lower edge 50 is not parallel to the louver axes A, the problem of the prior art shutter panels is presented. That is, in a typical prior art shutter panel, the upper louver or louvers 21 are fixed or have a limited rotation. To overcome this problem, the invention presents the recesses 70, seen in FIG. 6.

Recess or recesses 70 are located on the back 72 of the top rail 12. One or more recesses 70 may be used depending on the degree of curvature of the top rail and the width of the louvers. For example, FIG. 6 shows two recesses for receiving two upper louvers 21. The recesses 70 are not apparent from the front side 60 of the shutter panel, as seen in FIG. 5. The front 74 of the top rail 12 appears normal. A recess 70 in the back 72 of the top rail 12 cooperates with an upper louver 21, providing room for the louver 21 to rotate without interference from the top rail 12. The recess 70 may also provide a surface for connection of the upper louver 21 to a pivot face, as will be seen. Additionally, the upper louver or louvers 21 may have a notch 100 cut therein to facilitate rotation of the louver 21.

FIGS. 5 and 6 show the louvers 20 in a partially open position. The louvers 20 are connected one to another via tilt rod 30 along the front of the panel. The tilt rod 30 is centered in the middle of the louvers; however, an off-centered tilt rod may be used as desired. Where a centered tilt rod 30 is employed, it may not be possible to connect the tilt rod 30 to the upper louver or louvers 21. For example, in FIG. 6, the top louver 21 is not connected to tilt rod 30. In such a case, it is desirable to use a rear tilt rod 31 to connect the upper louver 21 to at least one of the louvers 20 controlled by tilt rod 30. Such a design allows for the simultaneous rotation of all of the louvers by movement of the tilt rod 30.

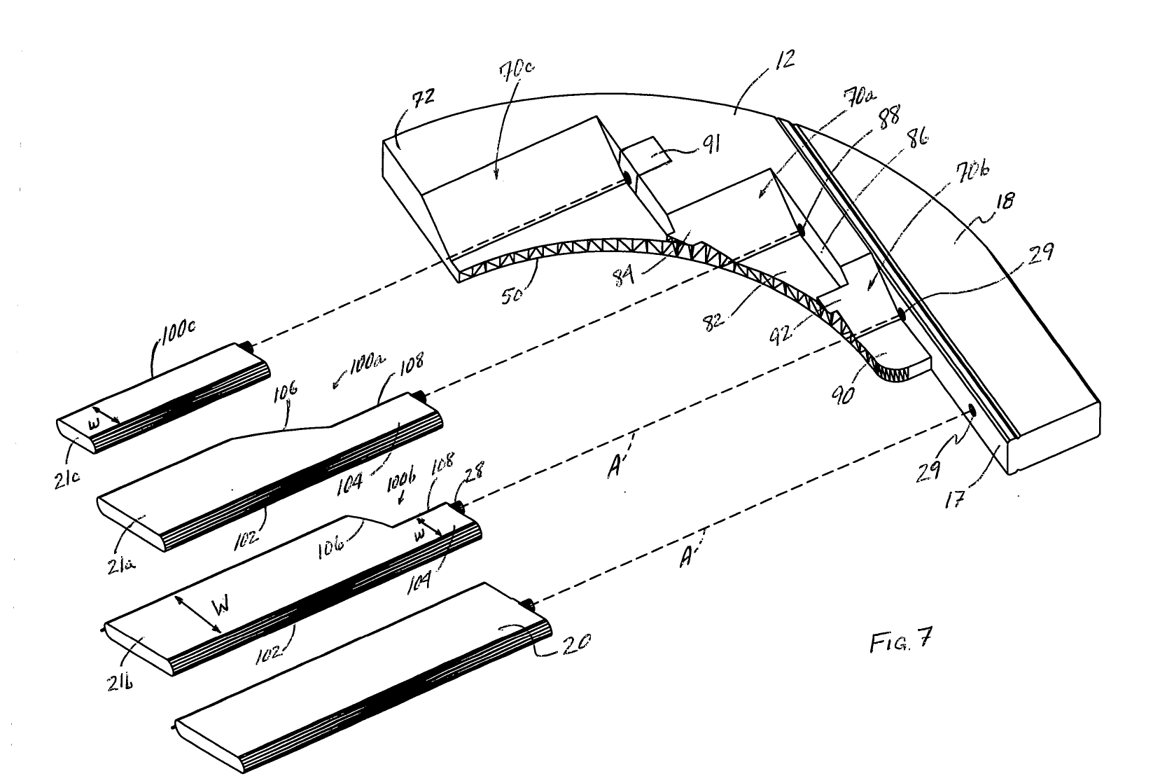

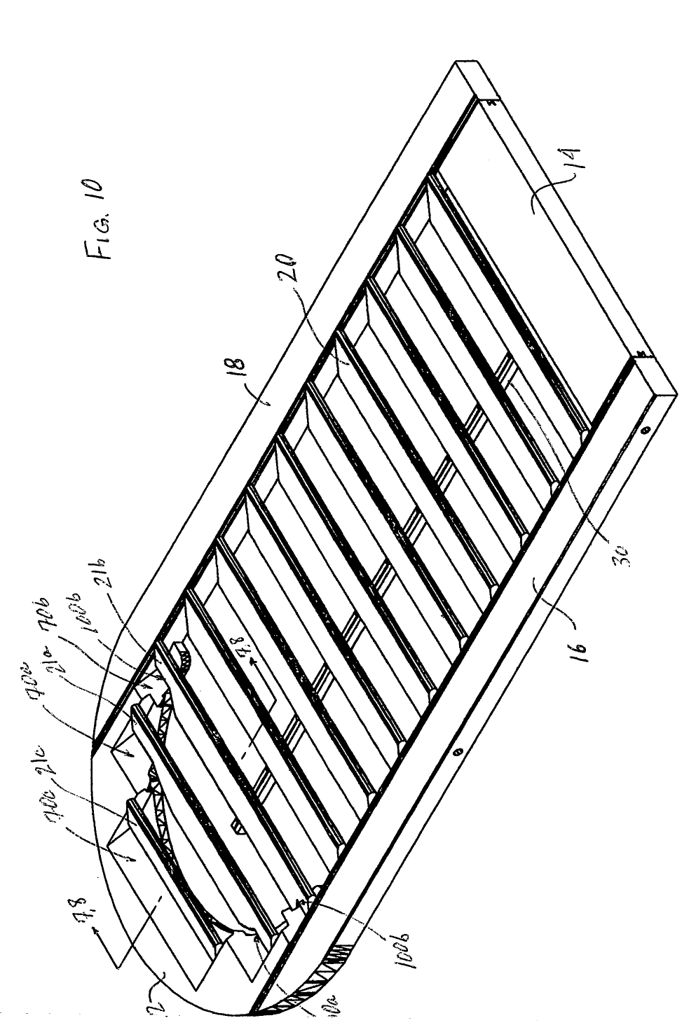

FIG. 7 presents an exploded and partially cut-away view of the upper portion of the shutter panel 10 of FIG. 10 viewed from the back. Stile 18 with a plurality of pivot holes 29 in the stile pivot face 17 is presented. Top rail 12 is connected to the top end of the stile 18. Three types of recess 70 are presented in the back 72 of top rail 12, referred to as recesses 70a, 70b and 70c. Recess 70a in top rail 12 presents a lower face 82, an upper face 84 and a rail pivot face 86. Rail pivot hole 88 is located in rail pivot face 86. One of the upper louvers, 21a, mates with recess 70a. Tenon 28 of louver 21a corresponds to rail pivot hole 88. The louver 21a has a notch 100a cut therein.

Similarly, recess 70b presents a lower face 90 and upper face 92. One of the upper louvers, 21b, corresponds to recess 70b. Recess 70b, unlike recess 70a, does not have a rail pivot face since the pivot face 17 of stile 18 provides a pivot hole 29 for upper louver 21b. The tenon 28 of louver 21b mates with a pivot hole 29 in stile 18 providing a pivot point for the louver. Upper louver 21b also has a notch 100b cut therein. The combination of the notch in the louver and the corresponding recess in the top rail allows each upper louver to rotate along its pivoting axis A. The number and exact shape of the recesses 70a, 70b and 70c will depend on the shape of the top rail 12, however, each of the recesses works based on the same principles.

Recess 70a provides a pivot hole 88 in the recess pivot face 86. It is preferred that the pivot face 86 be approximately perpendicular to the louver axis A. This provides an ideal arrangement for rotational connection of the louver 21a to the face 86. Where pivot hole 88 is drilled, a generally perpendicular pivot face is desirable for ease of drilling. Other arrangements may be used, however, a pivot face 86 which is not perpendicular to the louver axis A will complicate creation of the pivot hole and could strain the connection between the louver and top rail via pin 28. For example, the drilling of the pivot hole 88, which should be parallel to the louver axis, may prove more difficult when drilling into an angled pivot face 86. Further, an angled face may require additional adjustments to the louver end and pin design. In a recess such as that of 70b, the face 17 of stile 18 provides a pivot face perpendicular to the louver axis A. Again, this allows for ease of construction and operation.

The upper louvers each have a notch 100, cut-away or non-rectangular end-shape, to allow the louver to rotate along its pivot axis A without being impeded by the top rail 12. The louvers 21a and 21b are each a standard width “W” at their widest point. The notch 100 narrows the end of the louver to a narrower width “w” at or near the louver end 104. Ideally, the bottom edge 102 of the louver remains a straight edge, as shown, such that the bottom edges 102 of the upper louvers 21 parallel the bottom edges of the remaining louvers 20. This provides for more uniform louver shape when the shutter panel is viewed from the front.

The notch 100 may consist of a contoured portion 106 and an axial portion 108, as seen on louver 21a, or simply a contoured portion 106, as seen in FIGS. 5 and 6. The contoured portions 106 may be linear or curved, as desired. Preferably, the contoured portion 106 is curved to match the curvature of the lower edge 50 of the top rail 12. The specific design and dimensions of the notch will depend on the shape and size of the shutter panel and width of the louvers. The axial portion 108 should be generally parallel to the louver axis A. The axial portion 108 extends a distance, which cooperates with the length of the recess adjacent the louver axis. That is, linear portion 108 must be long enough that the rail does not interfere with the contoured portion 106 during rotation of the louver. At the louver end 104, the louver width “w” should correspond to the louver axis A to allow for placement of the pin 28 in alignment with the axis A.

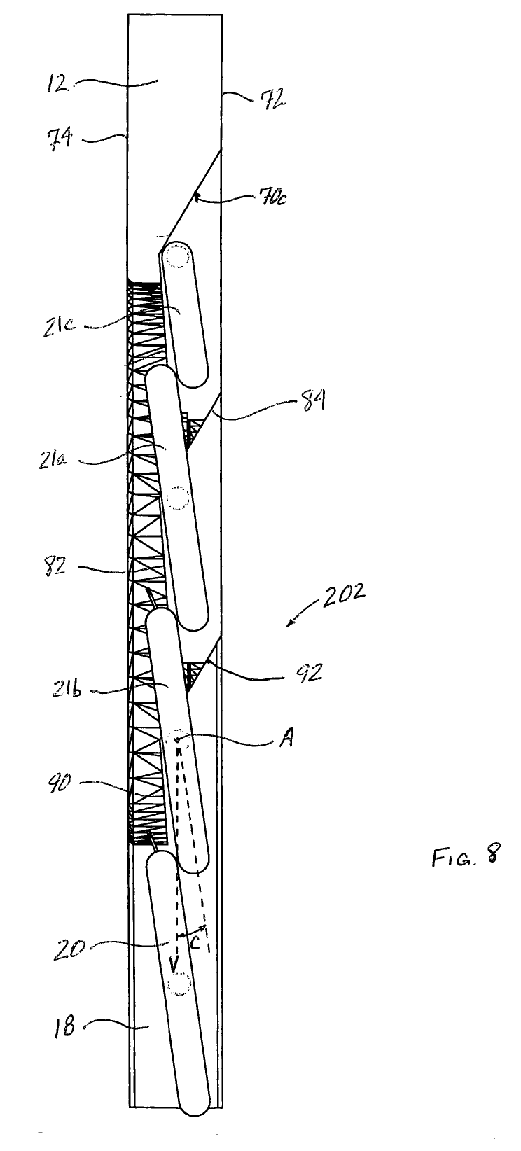

The coordination of the notch and recess ideally allow the upper louver 21 to rotate to a fully closed position 202, best seen in FIG. 8, parallel to the remaining louvers 20. The louvers rotate to a fully closed position only a few degrees, angle C, from a vertical line V. In this position, adjacent louvers abut or nearly abut one another thereby blocking light from entry through the shutter panel. The exact variance from vertical in the fully closed position is not critical and may vary with varying louver sizes and shapes. In practice, in the closed position the louvers may be approximately 4-13 degrees from the vertical. The invention allows for rotation of the upper louvers 21 to the same degree as the remaining louvers 20. The upper and remaining louvers may be operated in unison by the operation of the tilt rods 30 and 31.

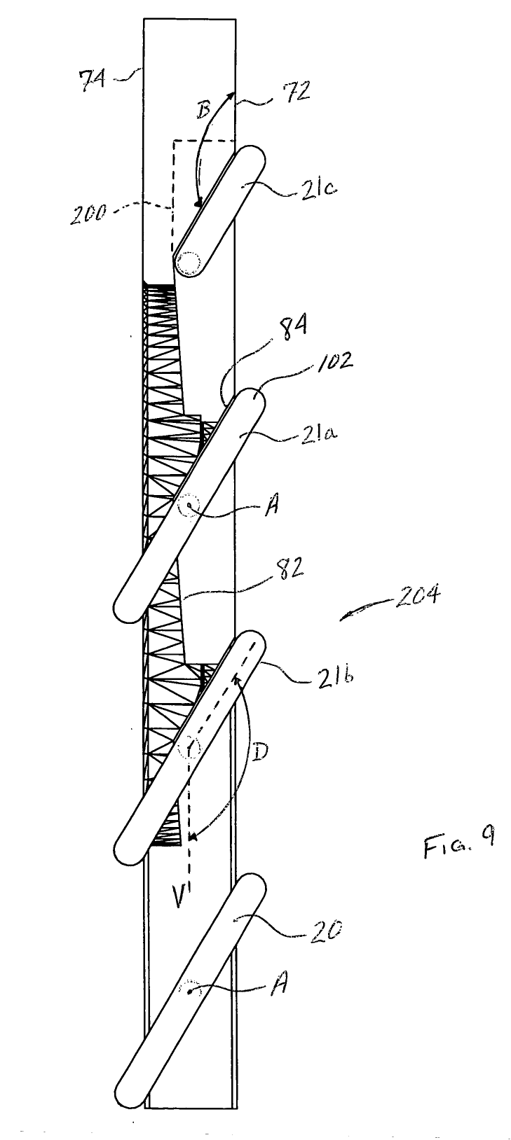

Both recesses 70a and 70b provide upper faces 84 and 92, respectively. Those skilled in the art will realize that the placement of the upper faces and the angle at which they are slanted with respect to the back face 72 of the top rail 12 will impact the degree of rotation of the upper louver 21. In the fully closed position 202, the upper louvers 21a and 21b will ideally not contact the lower faces 82 and 90, respectively. The notch 100 on upper louver 21a, for example, is preferably cut such that the upper face 84 of the recess 70a does not interfere with rotation of the louver 21a when the louver is in the fully closed position. In the fully open position 204, however, the bottom portion of the louver 21a, near bottom edge 102, may contact the recess upper face 84. This arrangement is best seen in FIG. 9. Similarly, the other upper louvers may abut or nearly abut the upper faces of their respective recess. As the angle B of the upper face 84 is increased with respect to the back face 72 of the top rail 12, the upper louver 21 is allowed a greater degree of rotation in the open direction. Alternately, if the recess is defined along dotted line 200, the upper louver may rotate to a limit of rotation, position 204, wherein adjacent louvers abut one another. In many shutter panel applications, it may not be desirable to provide for movement into a nearly vertical fully open position since other restrictions may limit movement of the louvers. For example, the bottom rail, light traps or tilt rod connection may interfere with rotation of the louvers. In a preferred embodiment, seen in FIG. 9, the fully open position 204 allows rotation of the upper louvers 21 to an angle D with respect to the vertical V. This angle is preferably at least 90 degrees from vertical. In one preferred embodiment, this angle is at least 120 degrees from vertical. FIG. 9 shows rotation to 150 degrees from vertical. The exact angle to which the upper louvers 21 may rotate is not critical and may be selected by the designer. The invention allows the upper louvers 21 to rotate to a fully closed position parallel to that of the remaining louvers 20. That is, the upper louvers and remaining louvers each rotate to the same degree. This allows all of the louvers to operate through the same degree of rotation and be simultaneously controlled by movement of the tilt bars.

FIGS. 7 and 10 also present a flapper upper louver 21c and recess 70c. The curvature of the arch of the top rail 12 and size of the louvers may result in the shown arrangement, where the recess 70c is a long as the upper louver 21c. A flapper upper louver 21c cooperates with the long recess 70c. The flapper louver 21c is a width “w” along its entire length, which is less than the full width “W” of the other louvers. Preferably the width “w” of the flapper louver is somewhat greater than half of the width “W” of the remaining louvers and is similar to the narrower width “w” of notched upper louvers such as 21a and 21b. The flapper louver 21c may be considered to have a notch 100c, which extends the entire length of the louver, or may be viewed as having the linear portion 108o extending in cooperative relationship with the length of the recess 70c.

A recess 70 and notch 100 cooperate to provide space for the rotation of an upper louver 21, as seen in the Figures. The exact dimensions of the recess will depend on the size of the top rail 12 and stile 16, the degree of arch of the top rail and the width of the louver 21. An exemplary shutter panel has 3¼ inch louvers, stiles approximately 2¼ inches wide and 1⅛ inch thick and a top rail approximately 3¼ of a circle with approximately 36 inch radius. On such a shutter panel, the recess 70a is approximately ¾ inch deep at its deepest and lower face 82 is about 1⅝ inches wide along pivot face 86. The recess must be at least wide enough at the lower face to allow placement of the pivot hole 88 in the rail pivot face 86 of the recess. These measurements are exemplary only. It is understood that the measurements will vary with shutter panel and louver size and shape.

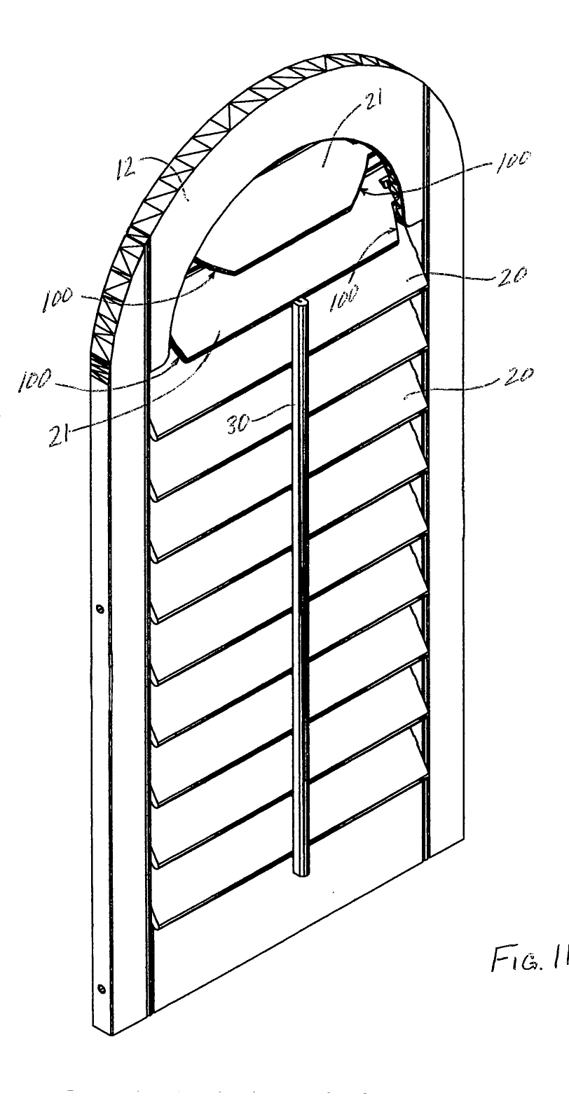

As shown in the Figures, a recess 70 may take various shapes, such as those of recesses 70a, 70b and 70c. Where the top rail 12 is a wider arch, such as in FIGS. 10 and 11, or a semi-circle, recesses 70 may be provided for both ends of the upper louvers 21, as seen in FIG. 10. The design may be modified to provide for one, two, three or more upper louvers requiring recesses for full operation. FIG. 10 presents three upper louvers 21. Where recesses 70 are provided for each end of the upper louver 21, it may be necessary to provide a notch 100 on each end of the louver, as best seen in FIG. 11.

FIG. 10 presents a rear view of a shutter panel having an upper louver 21a, which attaches at both ends to upper rail 12. FIG. 7 presents a more detailed view of the louver end and connection to the rail. The tenons 28 at both ends of the louver 21a rotatably connect to pivot holes 88 in a rail pivot face 86. Such an arrangement presents a manufacturing challenge. Most louvers, such as louvers 20 and upper louver 21b, which connect to the stiles, can be arranged in alignment with corresponding pivot holes 29 before the panel is assembled. That is, the parts of the panel, including the louvers, are arranged as in FIG. 1A and then brought together as in the assembled view in FIG. 1. Such a manufacturing process is not possible when both ends of the louver attached to the rail 12. Spring-loaded, retractable tenons or other methods may be employed. Alternatively, a piece 91, as seen in FIG. 7, of the rail 12 can be inserted into the rail after placement of the louver tenon either into a pivot hole 29 in the piece 91 itself or into the rail 12. The piece 91 can be cut-out of the rail or supplied separately.

The inventive recessed-rail and notched-louver design may be employed for partial or semi-circular shutter panels having parallel louvers or for the upper louvers of eyebrow shutter panels. Similarly, the design may be modified for circular and elliptical shutter panels with parallel louvers. Although the Figures herein show horizontal louvers, since this is the more typical design, the invention lends itself to use in any shutter panel having parallel louvers, whether horizontal, vertical or at any other angle.

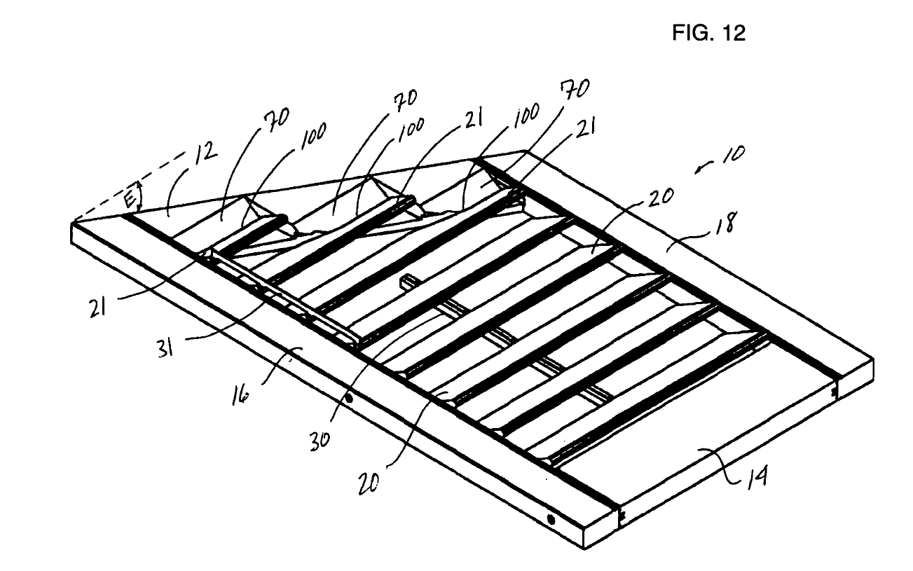

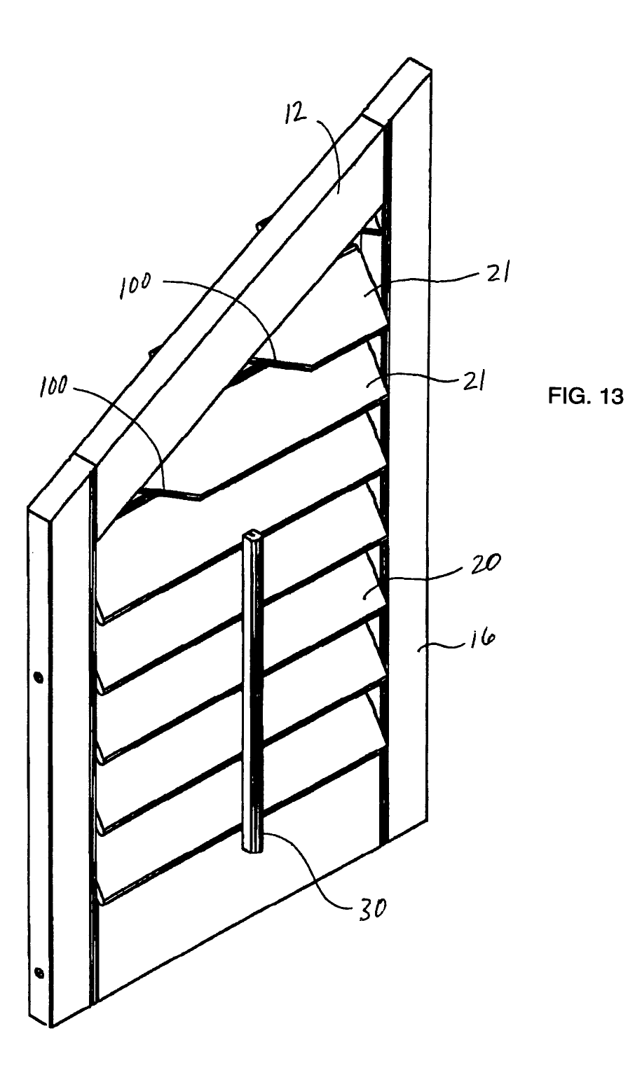

FIGS. 12 and 13 show a shutter panel 10 with an angled top rail 12. That is, the top rail 12 is linear but not perpendicular to the panel stiles 16 and 18. In the prior art, it is typical for the upper louver 21 or louvers to be fixed or have a limited degree of movement. Angle E, as seen in FIG. 12, indicates the degree of angle between a horizontal line and the top rail 12. In the prior art, where angle E is 25 degrees or less, the upper louvers 21 are fixed. Even where the angle is greater than 25 degrees, the upper louvers 21 have limited movement. Use of the invention allows the upper louvers 21 on an angled top rail shutter panel to operate through a range of rotation identical to that of the louvers 20 not in the effected area. All of the louvers may then be operated simultaneously through use of the tilt rods 30 and 31. Just as with the arched shutter panels described above, the tilt rod 30 may be centered, as shown, or off-center. Use of rear tilt rod 31 allows simultaneous operation of all of the louvers through use of the centered tilt rod 30 from the front of the shutter panel.

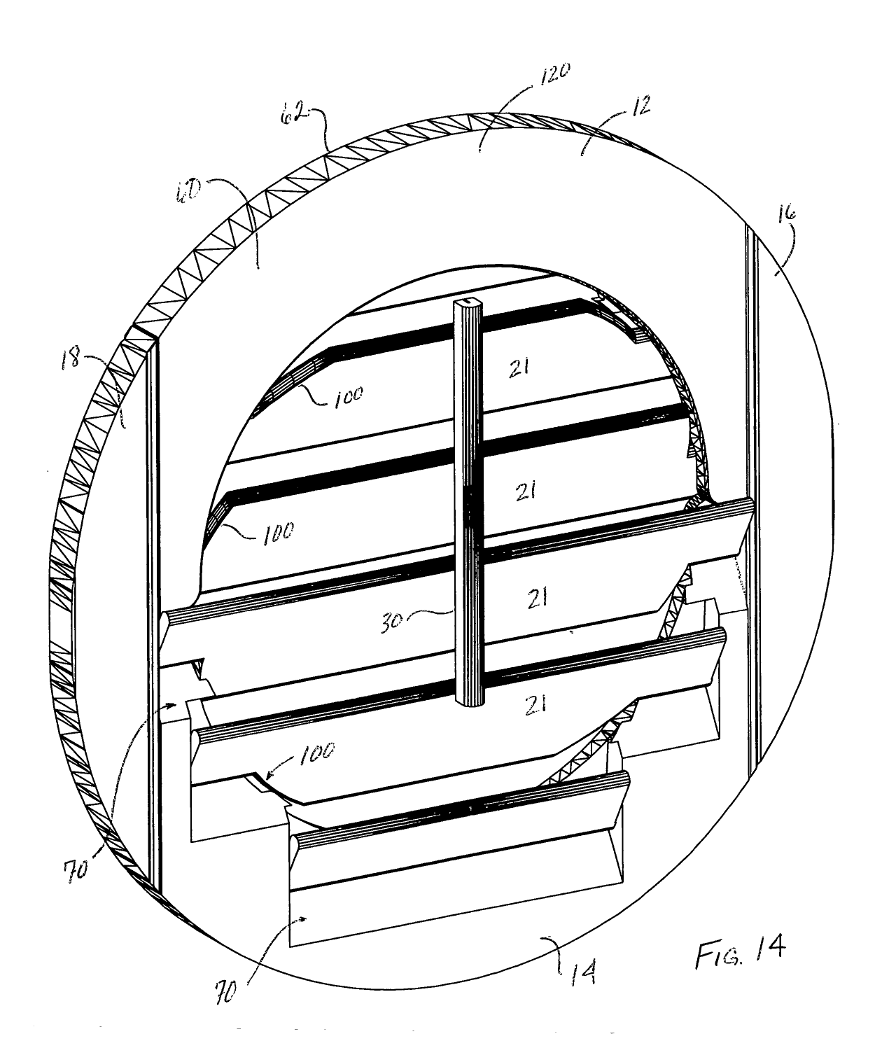

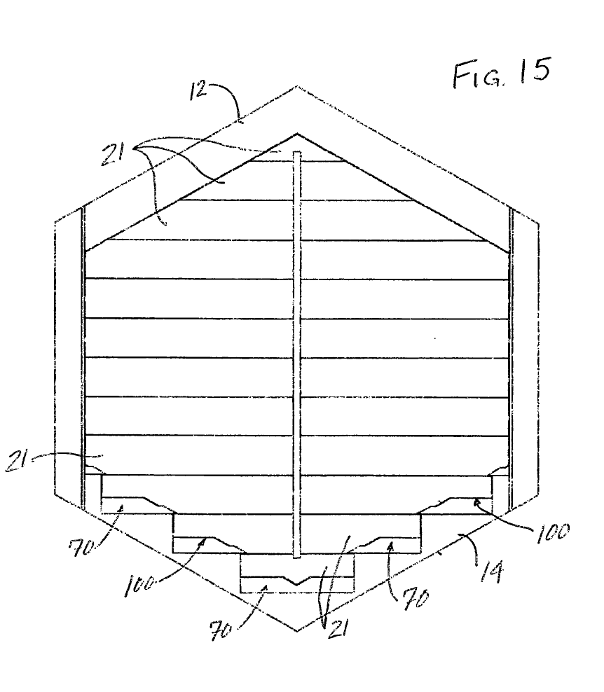

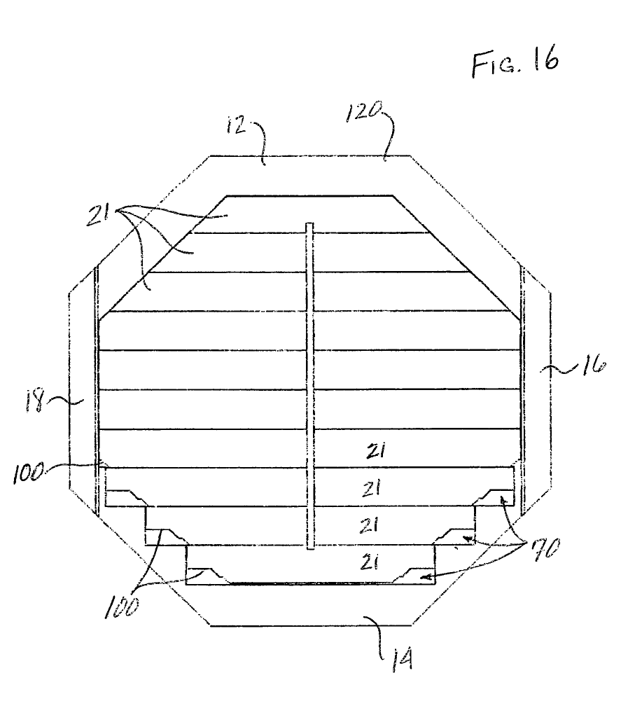

FIGS. 14-16 show application of the cooperating notched louvers 21 and recesses 70 in circular, hexagonal and octagonal shutter panels. Other panel shapes can be used. In such shaped panels, where the upper 12 and lower 14 rails are both arched or non-rectangular, it is necessary to employ recesses 70 on both the front side 60 and the back side 62 of the shutter panel. The front view of FIG. 14 shows recesses 70 along the front of bottom rail 14. Similar recesses 70 are employed on the back of top rail 12. Notches 100 are employed on all of the louvers 21. For ease of manufacture, the frame 120 is made of rails 12 and 14 and stiles 16 and 18. Other arrangements, such as a frame 120 made of a single-piece, are possible. FIGS. 15 and 16 present similar arrangements, although the hexagonal and octagonal shutter panels allow for a number of traditional louvers 20 co-extensive with the vertical stiles 16 and 18. Just as in the circular frame, the panels in FIGS. 15 and 16 employ recesses on both the front and back sides of the panel.

Preferred embodiments have been described herein, but it is understood that this has been done solely to describe various aspects of the invention, and it is not intended to limit the scope of the invention as defined in the Claims. Those skilled in the art will realize that the embodiments shown are exemplary and that various substitutions, alterations and modifications may be made in the practice of the invention.

1. A shutter panel apparatus comprising:
a shutter frame having a pair of stiles, spaced apart and generally parallel to one another, and a bottom rail and a top rail, each connected to the stiles;
a plurality of generally parallel louvers rotatably connected to the shutter frame such that each louver is rotatable along a longitudinal axis, the plurality of louvers including an upper louver, the upper louver having a first and a second end;
wherein the top rail is non-linear in shape and has a back face and a front face, the back face of the top rail having a recess defined therein for receiving the first end of the upper louver, the first end of the upper louver rotatably connected to the top rail.

2. An apparatus as in claim 1 wherein the top rail is arched.

3. An apparatus as in claim 1 wherein the top rail is semi-circular.

4. An apparatus as in claim 1 wherein the top rail is elliptical.

5. An apparatus as in claim 1 wherein the louvers are capable of rotating through a degree of rotation and wherein the upper louver is rotatable through the same degree of rotation.

6. An apparatus as in claim 5 wherein the louvers rotate from a fully closed position wherein the louvers are within 4 to 13 degrees of vertical.

7. An apparatus as in claim 5 wherein the louvers rotate to an open position of at least 120 degrees from the vertical.

8. An apparatus as in claim 5 wherein the louvers rotate to an open position of at least 150 degrees from vertical.

9. An apparatus as in claim 1 wherein the first end of the upper louver has a notch.

10. An apparatus as in claim 9 wherein the notch in the first end of the upper louver cooperates with the recess in the top rail to allow the upper louver to rotate through a range of motion about a longitudinal axis to a greater extent than without the notch.

11. An apparatus as in claim 9 wherein the notch is defined by at least one axial portion and at least one contoured portion.

12. An apparatus as in claim 9 wherein the notch is defined by at least one contoured portion.

13. An apparatus as in claim 12 wherein the contoured portion is linear.

14. An apparatus as in claim 1, the apparatus having a plurality of upper louvers, each having a first and a second end, the top rail having a plurality of recesses defined therein corresponding to the upper louvers, the plurality of recesses for receiving a corresponding first end of a upper louver, the first ends of the upper louvers connected rotatably to the top rail.

15. An apparatus as in claim 1, the top rail of the apparatus having a second recess therein, the second recess for receiving the second end of the upper louver, the second end of the upper louver rotatably connected to the top rail.

16. An apparatus as in claim 1, the top rail having a second recess, the apparatus having a second upper louver with a first end, the second recess for receiving the first end of the second upper louver, the first end of the second upper louver rotatably connected to the top rail.

17. An apparatus as in claim 1 further comprising a tilt rod connected to at least a plurality of the louvers.

18. An apparatus as in claim 17 wherein the tilt rod is located on the front of the shutter panel.

19. An apparatus as in claim 1 wherein the front face of the top rail has a top and bottom edge and wherein the top and bottom edge are generally parallel to one another.

20. An apparatus as in claim 1 wherein the tope rail is angled with respect to the stiles at an angle of less than 25 degrees.

21. An apparatus as in claim 1 wherein the recess is defined in part by a pivot face, the first end of the upper louver rotatably connected to the pivot face, wherein the pivot face is generally perpendicular to the longitudinal axis of the upper louver.

22. An apparatus as in claim 21 wherein the recess is defined in part by an upper face and a lower face, the upper face perpendicular to the lower face.

23. An apparatus as in claim 1 wherein the recess is defined in part by a pivot face, the pivot face having a pivot hole therein, the first end of the upper louver having a pin therein, the pin rotatably connected to the pivot hole such that the upper louver pivots about its longitudinal axis.

24. An apparatus as in claim 23 wherein the pivot face is generally perpendicular to the longitudinal axis of the upper louver.

25. A window shutter apparatus comprising:
a frame;
a plurality of generally parallel louvers each rotatable along a longitudinal axis through a range of motion;
a recess in the frame for receiving an end of a corresponding louver, the received louver rotatably attached to the frame, and a notch in the end of the received louver the notch cooperating with the recess to allow rotation of the received louver.

26. An apparatus as in claim 25 wherein at least a portion of the frame is semi-circular.

27. An apparatus as in claim 25 wherein at least a portion of the frame is circular.

28. An apparatus as in claim 25 wherein at least a portion of the frame is elliptical.

29. An apparatus as in claim 25 wherein the frame is generally rectangular.

30. An apparatus as in claim 25 wherein the range of motion of the received louver is at least 90 degrees.

31. An apparatus as in claim 25 wherein the range of motion of the received louver is at least 110 degrees.

32. An apparatus as in claim 25 wherein the range of motion of the received louver is substantially the same as the range of motion for the remaining rotatable louvers.

33. A window shutter panel apparatus comprising:
a shutter frame describing, at least in part, an arch;
a plurality of generally parallel louvers rotatably connected to the shutter frame such that the louvers are each rotatable along a longitudinal axis through a substantially identical range of motion.

34. An apparatus as in claim 33 wherein every louver is movable through a range of motion of at least 100 degrees.

35. An apparatus as in claim 33 wherein every louver is movable through a range of motion of at least 120 degrees.

36. An apparatus as in claim 33 wherein the shutter frame comprises two stiles and two rails.

37. An apparatus as in claim 33 wherein the plurality of louvers includes an upper louver having a first end.

38. An apparatus as in claim 37 wherein the frame includes a recess, the first end of the upper louver at least partially located in the recess.

39. An apparatus as in claim 38 wherein the frame includes a stile and a top rail, and wherein the recess is in the top rail, and wherein the upper louver is rotatably connected to the stile.

40. An apparatus as in claim 38 wherein the frame includes a stile and a top rail, and wherein the recess is in the top rail, and wherein the upper louver is rotatably connected to the top rail.

41. An apparatus as in claim 40 wherein the recess includes a pivot face, the upper louver rotatably connected to the pivot face.

42. An apparatus as in claim 41 wherein the pivot face is generally perpendicular to the longitudinal axis of the upper louver.

43. An apparatus as in claim 33 where in the shutter frame is circular.

44. An apparatus as in claim 33 where in the shutter frame is hexagonal.

45. An apparatus as in claim 33 where in the shutter frame is octagonal.

46. A window shutter panel apparatus comprising:
a circular shutter frame;
a plurality of generally parallel louvers rotatably connected to the shutter frame, the louvers are each rotatable along a longitudinal axis.
